(19) United States
(12) Patent Application Publication
(10) Pub. No.: US 2008/0185365 A1
(43) Pub. Date: Aug. 7, 2008

(54) Flatbed laser engraver

(75) Inventors: Yung-Hui Yang, Hsi Chih City (TW); Hung-Fei Kuo, Hsi Chih City (TW)

Correspondence Address: TROXELL LAW OFFICE PLLC, SUITE 1404, 5205 LEESBURG PIKE, FALLS CHURCH, VA, 22041, US

(73) Assignee: Great Computer Corporation

(21) Appl. No.: 11/701,547

(22) Filed: Feb. 2, 2007

(51) Int. Cl. B23K 26/00

(52) U.S. Cl. 219/121.6

(57) ABSTRACT

A flatbed laser engraver comprises a working platform for fixing a workpiece thereon and a carriage moving back and forth on a guiding rail of the working platform. It is characterized in that the flatbed laser engraver further comprises a quantum cascade laser output device disposed on the working platform. The quantum cascade laser output device is connected to the power supplying device of the flatbed laser engraver on one end and connected to the carriage on another end for providing the laser output energy that the carriage needs.

### FIELD OF THE INVENTION

The present invention is related to a flatbed laser engraver, and particularly to a flatbed laser engraver having a quantum cascade laser output device which is disposed on a working platform or a carriage for replacing the carbon dioxide laser tube to reduce or dismiss the use of the reflect mirror. It can reduce the distance of the optic path effectively and prevent the watt loss of the laser.

### DESCRIPTION OF THE PRIOR ART

The basic principle of the laser engraver is to guide and focus the light beam outputted by the laser onto the surface of an object. The focused light beam is absorbed by the material and raises the temperature steeply to cause gasification and concave on the surface of the object. The carving and cut can be achieved by using this process. The procedure of the laser engraving is as simple as that of printing paper by the computer and the printer. It can use multiple image processing softwares, e.g. CorelDraw (Corel Corporation), to process design on Win95/98. Scanned figures, vector graphics and numerous CAD type data could be “printed” easily by engravers. The only different part is that the common printing is to apply toner to paper and the laser engraving is to output laser to almost all materials, such as wood, acrylic, plastic board, metal board and stone board.

The carbon dioxide laser tube used in the traditional laser engraver is huge and must be set in the inner of the machine. By placement of several reflecting mirrors, the laser beam could be transferred to a carriage of the engraver by the reflecting mirrors. But the long transferring distance causes the watt loss of the laser. And different distances of the optic paths will result in different sizes of the laser spot. As a whole, the efficiency of use is not ideal. The adjustment, setup and dust-proof of the reflecting mirrors take money and time and are the cost that users take.

### SUMMARY OF THE INVENTION

The primary object of the present invention is to provide a flatbed laser engraver for replacing the carbon dioxide laser tube and decreasing, even dismissing, the use of the reflecting mirrors.

The secondary object of the present invention is to provide a flatbed laser engraver for reducing the distance of the optic path effectively and preventing the watt loss of the laser.

To achieve the above objects, the flatbed laser engraver of the present invention comprises a working platform for fixing a workpiece thereon and a carriage moving back and forth on a guiding rail of the working platform. It is characterized in that the flatbed laser engraver further includes a quantum cascade laser output device which is disposed on the working platform, connected to the power supplying device of the flatbed laser engraver on one end, and connected to the carriage on another end for providing the laser output energy that the carriage needs.

### BRIEF DESCRIPTION OF THE DRAWINGS

FIG. 1 is a perspective view of the flatbed laser engraver of an embodiment in accordance with the present invention;

FIG. 2 is a perspective view of the quantum cascade laser output fixed on the working platform in accordance with the present invention when in use; and

FIG. 3 is a perspective view of the quantum cascade laser output device fixed on the carriage of the working platform in accordance with the present invention when in use.

### DETAILED DESCRIPTION OF THE PREFERRED EMBODIMENT

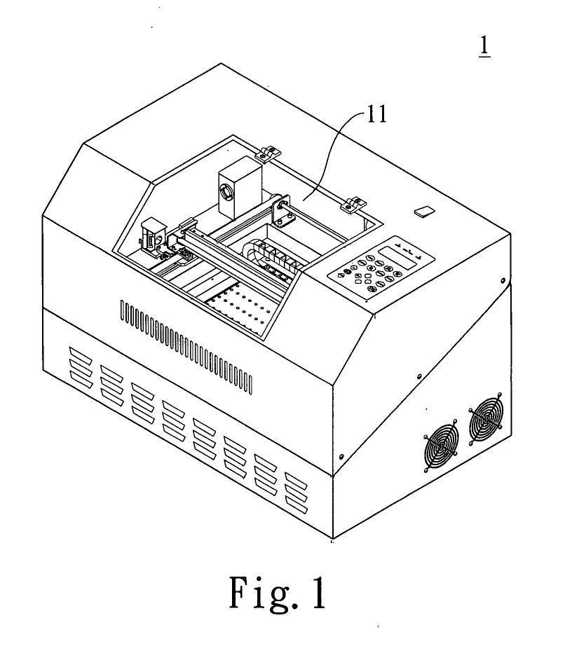

Referring to FIG. 1 to 3, these figures illustrate an embodiment of the flatbed laser engraver 1 in accordance with the present invention.

The flatbed laser engraver 1 comprises a working platform 11 for fixing a workpiece thereon. A carriage 12 on the working platform 11 can move back and forth on a guiding rail 13 of the working platform 11. The flatbed laser engraver 1 further comprises a quantum cascade laser output device 14. The output wavelength of the quantum cascade laser output device 14 is between 9 and 12 μm. The quantum cascade laser output device 14 is connected to the working platform 11, connected to the power supplying device of the flatbed laser engraver 1 on one end, and connected to the carriage 12 on another end for providing the laser output energy that the carriage 12 needs.

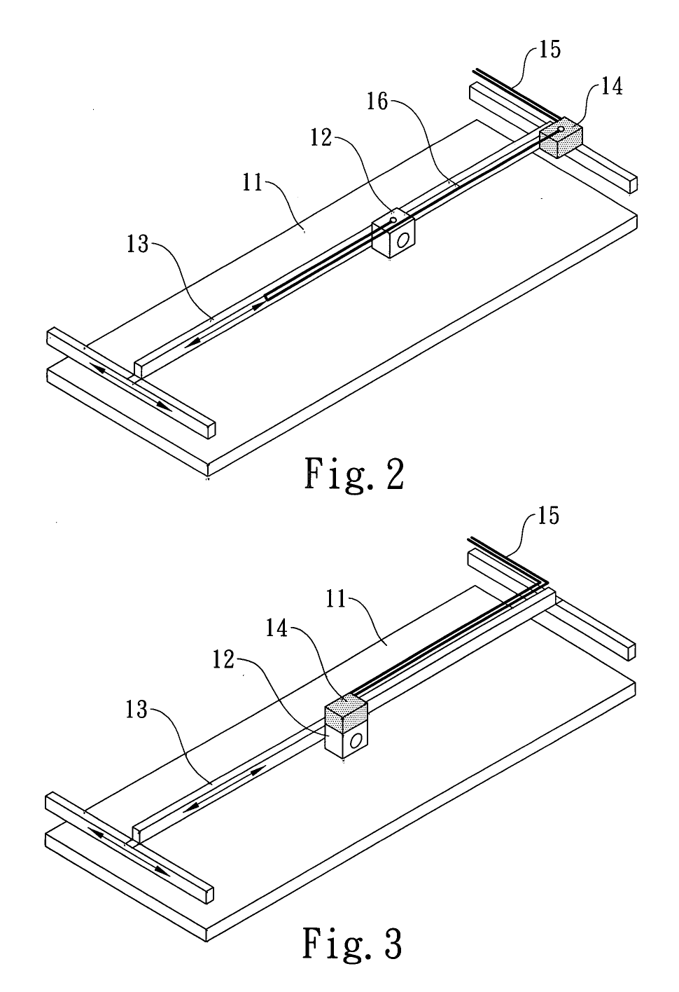

In practice, as shown in FIGS. 2 and 3, the quantum cascade laser output device 14 of the present invention could be fixed on the working platform 11 or on the carriage 12. Taking FIG. 3 as an example, the quantum cascade laser output device 14 is fixed on the working platform 11, connected to the power supplying device of the flatbed laser engraver 1 on one end by a transmitting line 15, and connected to the carriage 12 on another end by an optic fiber 16.

Thus, when the engraving work is operated, the quantum cascade laser output device 14 on the working platform 11 receives the movement data to output and to transfer laser beam to the carriage 12 by the optic fiber 16.

Referring to FIG. 3, the quantum cascade laser output device 14 is directly fixed on the carriage 12 of the working platform 11. The quantum cascade laser output device 14 is connected to the power supplying device of the flatbed laser engraver 1 by the transmitting line 15 on one end and transfers laser beam to the carriage 12 directly on another end without any light-conducting device.

Thus, the flatbed laser engraver 1 of the present invention is provided on the working platform 11 or the carriage 12 with the quantum cascade laser output device 14 with the wavelength of 10 μm which is almost equal to the wavelength of 10.6 μm of the carbon dioxide laser tube. It has the advantages of small volume, high integration and fast operating frequency. The quantum cascade laser output device 14 on the working platform 11 or the carriage 12 could reduce, or even dismiss, the use of reflecting mirror to decrease the distance of optic path and prevent the watt loss of the laser and have the advantage of easy maintenance, simple assembly/detachment, and low cost.

Although the present invention has been disclosed and illustrated with reference to particular embodiments, the embodiments are not for giving any limitation to the scope of the present invention. It will be apparent to those skilled in this art that various modifications or changes can be made to the elements of the present invention without departing from the spirit and the scope of this invention also falls within the scope of the appended claims and is intended to form part of this invention.

As stated in the above disclosed, the present invention can surely achieve its expected objects to provide a flatbed laser engraver with a quantum cascade laser output device which is applicable in industry.

1. A flatbed laser engraver comprising a working platform for fixing a workpiece thereon, and a carriage moving back and forth on a guiding rail of the working platform, being characterized in that:
a quantum cascade laser output device being disposed on the working platform, connected to a power supplying device of the flatbed laser engraver on one end, and connected to the carriage on another end for providing the laser output energy that the carriage needs.

2. The flatbed laser engraver as claimed in claim 1, wherein the quantum cascade laser output device is fixed on the working platform, connected to the power supplying device of the flatbed laser engraver by a transmitting line, and connected to the carriage for transferring laser beam by optic fiber.

3. The flatbed laser engraver as claimed in claim 1, wherein the quantum cascade laser output device is fixed on the carriage of the working platform directly, connected to the power supplying device of the flatbed laser engraver by a transmitting line, and transferring laser beam to the carriage directly.

4. The flatbed laser engraver as claimed in claim 1, wherein the output wavelength of the quantum cascade laser output device is between 9 and 12 μm.
